(19) United States
(12) Patent Application Publication
(10) Pub. No.: US 2016/0121676 A1
(43) Pub. Date: May 5, 2016

(54) WHEEL GUIDE ASSEMBLY FOR A VEHICLE WHEEL

(71) Applicant: Benteler Automobiltechnik GmbH, Paderborn (DE)

(72) Inventors: Rodscha DRABON, Salzkotten (DE); Rudi TÖWS, Paderborn (DE); Jürgen VON-DER-KALL, Paderborn (DE); Armin ZUBER, Paderborn (DE)

(73) Assignee: Benteler Automobiltechnik GmbH, Paderborn (DE)

(21) Appl. No.: 14/932,249

(22) Filed: Nov. 4, 2015

(30) Foreign Application Priority Data
Nov. 4, 2014 (DE) 10 2014 116 077.0

(51) Int. Cl. B60G 7/00; B60G 3/02

(52) U.S. Cl. CPC B60G 7/001; B60G 3/02; B60G 2204/418

(57) ABSTRACT

The present invention relates to a wheel guide assembly for a wheel of a vehicle, comprising: a bearing bolt (101), a wheel control arm (103) which comprises a bearing (105) with a bearing eye (107), wherein the bearing bolt (101) is extended through the bearing eye (107), a bearing support (115) having a first support limb (119) and a second support limb (121) for accommodating the bearing (105) of the wheel control arm (103), wherein a first guide recess (123) is formed in the first support limb (119, 505) and a second guide recess (125) is formed in the second support limb (121, 507) for the guided displacement of the bearing bolt (101) into a specific mounted position, wherein the bearing bolt (101) is extended through the first guide recess (123) and the second guide recess (125), and a first retaining element (127) and a second retaining element (129) which hold the bearing bolt (101) in the specific mounted position in the first guide recess (123) and in the second guide recess (125), wherein the first retaining element (127) is inseparably connectable to the first support limb (119) and wherein the second retaining element (129) is inseparably connectable to the second support limb (121).

The present invention relates to a wheel guide assembly having a wheel control arm.

Wheel control arms which connect a wheel mount to a vehicle body, for example toe links or camber links, are normally used to adjust the alignment or camber of a vehicle wheel. Wheel alignment is for example factory-adjusted by statically adjusting a toe angle, which specifies a wheel's inclination to the vehicle's longitudinal axis, via the displacing of a toe link in the vehicle's transverse direction.

However, the adjusted toe angle changes dynamically during travel as a function of wheel stroke in the vehicle's vertical direction resulting from the compressing and rebounding of the wheel. In the ideal case, the change in the toe angle; i.e. the toe angle gradient, follows a target characteristic curve which associates different wheel strokes with toe angles. Due to manufacturing and component tolerances, however, toe link assemblies can for example vary within a certain tolerance range in different vehicles, which in various vehicles can lead to unwanted deviations of the dynamic toe angle changes from the target characteristic curve.

Published document DE 10 2010 000 204 describes an efficient active wheel alignment device able to hydraulically reduce such deviations.

The present invention addresses the task of specifying a passive wheel control arm assembly able to reduce an effect of manufacturing and component tolerances on the dynamic change to the toe or camber of a wheel within an axle system.

This task is solved by the features of the independent claims. Advantageous embodiments constitute the subject matter of the dependent claims, the accompanying figures as well as the description.

The present invention is based on the knowledge that the above task can be achieved by displacing a position of a wheel control arm bearing, particularly only one wheel control arm bearing, preferentially along a vertical vehicle axis; i.e. in the direction of gravity, and a subsequent fixing of the bearing. Adapting a force vector gradient acting along the wheel control arm relative to a wheel centre plane can in particular at least partly compensate any potential component or manufacturing tolerances.

The position of the toe link in the vehicle's vertical direction; i.e. the direction of gravity, particularly influences driving comfort and dynamics. If the toe gradient in the vehicle's vertical direction is set for example subject to empirical test data or numerical simulations, an area change in the toe angle, particularly the toe-in angle, can then be effected within a desired deviation and/or range of tolerance from the target characteristic curve. Doing so can improve both driving comfort as well as the driving dynamics.

A final tweaking to the wheel control arm assembly can hereby be effected, particularly in a link assembly having a plurality of wheel control arms such as transverse links, camber links and toe links, in order to for example reduce the influence of component tolerances on the dynamic toe angle change, particularly a toe-in angle. Just lifting or lowering the wheel control arm bearing by a few millimeters, e.g. by 1 mm, 2 mm, 3 mm, 4 mm or 5 mm, can hereby suffice in achieving the desired fine-tuning. Doing so can thus reduce the deviation of the wheel stroke-dependent toe angle gradient from a target characteristic curve.

According to one aspect, the invention relates to a wheel guide assembly for a wheel of a vehicle having a bearing bolt, a wheel control arm which comprises a bearing with a bearing eye, whereby the bearing bolt is extended through the bearing eye, a bearing support having a first support limb and a second support limb for accommodating the bearing of the wheel control arm, whereby a first guide recess is formed in the first support limb and a second guide recess is formed in the second support limb for the guided displacement of the bearing bolt into a specific mounted position, whereby the bearing bolt is extended through the first guide recess and the second guide recess, and a first retaining element and a second retaining element which hold the bearing bolt in the specific mounted position in the first guide recess and in the second guide recess, wherein the first retaining element is inseparably connected or connectable to the first support limb and wherein the second retaining element is inseparably connected or connectable to the second support limb.

The terms “inseparably connected” or “inseparably connectable” mean that there is no non-destructive way to break the inseparable connections between the retaining elements and the support limbs.

The inseparable connections can be the only connections existing between the retaining elements and the support limbs.

The support limbs are preferentially fixedly attached to the bearing support. The bearing support and the support limbs can be realized by a single integral component. The bearing support can either be affixed to a vehicle frame, or the vehicle body respectively, or at the wheel end, for example to a wheel mount.

The specific mounted position can for example be determined empirically and preset.

One advantage of the wheel guide assembly is that an assembly of the wheel control arm bearing in the bearing support can be factory-adjusted prior to the bearing being fixed by the inseparable connections. To adjust the bearing assembly, the bearing bolt can be raised or lowered along the guide recesses, e.g. along a vertical vehicle axis, by means of the retaining elements. The guide recesses establish possible motion trajectories for the bearing bolt. The retaining elements thereby support the bearing bolt in the guide recesses which can run parallel to a vertical vehicle axis and can thus be displaced in parallel by the retaining elements, whereby a position of the wheel control arm bearing can be corrected.

To set or adjust a toe setting, only one bearing of the wheel control arm, e.g. the wheel-side bearing or the frame-side bearing, is preferentially brought into the mounted position. The respective other bearing can be statically articulated. Doing so can effect a particularly simple adjustment of for example a toe gradient.

The guide recesses are preferentially oblong. The longitudinal extension of the respective guide recess can be dimensioned so as to enable a displacement of the bearing bolt in the respective recess of up to 1 mm, 2 mm, 3 mm, 4 mm 5 mm or 10 mm. The width of the guide recesses can correspond to the cross-sectional dimension of the bearing bolt so that the bearing bolt can be held and/or guided by the side edges of the guide recesses during mounting. The end of the bearing bolt is extended through the two guide recesses and can thereby be guided along said guide recesses.

According to one embodiment, the wheel control arm is a toe link or a camber link.

According to one embodiment, a longitudinal axis of the first guide recess and a longitudinal axis of the second guide recess extend perpendicular to a longitudinal axis of the bearing bolt. Doing so can effect a parallel displacement of the bearing bolt during a mounting process.

According to one embodiment, a longitudinal axis of the first guide recess and a longitudinal axis of the second guide recess extend parallel to a vertical axis of the vehicle, particularly within a tolerance range. The vertical vehicle axis can extend along a plumb-line direction and be perpendicular to a longitudinal vehicle axis. The tolerance range can be 1°, 5°, 10° or 15°.

According to one embodiment, the first guide recess and the second guide recess are each formed by an elongated hole. The elongated holes are preferably straight, which enables a displacement of the bearing bolt in one dimension, for example a raising or lowering.

The guide recesses preferably form vertical elongated holes which extend along the vehicle's vertical axis or at an angle to the vehicle's vertical axis. By so doing, the bearing can be lowered or raised in the bearing support during mounting in order to reach the mounted position.

The elongated holes can however also be curved. In this case, a two-dimensional displacement of the bearing bolt can be effected.

According to one embodiment, the first guide recess and the second guide recess are positioned in alignment with one another, thus allowing the bearing bolt to be displaced in parallel.

According to one embodiment, the first retaining element is arranged on the side of the first support limb and the second retaining element is arranged on the side of the second support limb. The retaining elements are arranged for example on side walls, particularly outer side walls of the support limbs, and are displaceable along the side wall prior to final fixation.

According to one embodiment, the first retaining element comprises a first support opening which is disposed above the first guide recess in the specific mounted position and the second retaining element comprises a second support opening which is disposed above the second guide recess in the specific mounted position, whereby the bearing bolt is extended through the first support opening and the second support opening, thereby enabling the retaining elements to displace and support the bearing bolt along the guide recesses.

According to one embodiment, an inner edge of the first support opening and an inner edge of the second support opening support the bearing bolt in the respective guide recess. The support openings can be circular or oblong and extend transverse to the extensions of the guide recesses.

According to one embodiment, the cross-sectional dimensions of the first support opening and the second support opening correspond to a cross-sectional dimension of the bearing bolt. This thereby holds the retaining bolt in the support opening.

According to one embodiment, the respective side of each of the support limbs facing the retaining element comprises at least one guide projection for the guided displacement or moving of the respective retaining element along the respective guide projection.

According to one embodiment, each support limb comprises two guide projections arranged on both side of the respective guide recess and running for example parallel to each other. This thus gives lateral support to the retaining elements.

According to one embodiment, the first retaining element and the second retaining element are each formed as an adjustment plate or an eccentric disk.

The adjustment plates can be rectangular sheet-metal pieces, for example centrically comprising a support opening for receiving the end of the bearing bolt extending through the respective guide recess. The adjustment plates are preferentially displaced transversely to displace the bearing bolt along the guide openings.

The eccentric disks are of e.g. round or eccentric form having a respective eccentrically arranged support opening for receiving an end of the bearing bolt extending through the respective guide recess. To displace the bearing bolt along the guide recesses, the eccentric disks are rotated, thereby displacing the support openings.

According to one embodiment, the first retaining element and the second retaining element each comprise at least one grip link for a continuous displacement of the first retaining element and the second retaining element along the respective guide recess in order to bring the bearing bolt into the specific mounted position. The retaining elements can be automatically displaced by means of a robotic arm or an actuator, which, when engaged with the grip links, can displace the retaining elements into the specific mounted position, the latter being pre-programmable.

According to one embodiment, the first retaining element is inseparably connected or connectable to the first support limb and the second retaining element is inseparably connected or connectable to the second support limb by at least one of the following inseparable connections: welded joint, rivet joint, solder joint, bonded joint, clinch connection or a pressing action.

According to one embodiment, the wheel control arm bearing is an elastomer bearing.

According to one embodiment, the bearing support is or can be fixed to an axle support of a frame of the vehicle or the bearing support is formed by a wheel mount.

According to one embodiment, the bearing bolt is a screw. The screw can comprise a nut and a screw head which act on the support limbs, whereby they are pressed together and screw down the bearing.

According to one embodiment, the bearing is clamped between the first support limb and the second support limb. The clamping force can be generated by means of the bearing bolt realized as a screw.

In accordance with one embodiment, it is advantageous for the toe gradient to be adjusted separately from the toe setting. Doing so can thus simplify the wheel guide mechanism when the wheel guide mechanism does not adjust the wheel control arm in the vehicle's transverse direction. Separately adjusting the toe gradient and the toe setting can furthermore reduce adjustment error.

The inseparable connection enables the toe setting or toe gradient to be statically adjusted. In order to effect dynamic setting or adjusting of the toe or toe gradient, an actuator can be additionally provided, as described below, which is arranged for example between the bearing block and the vehicle frame or wheel mount.

According to one embodiment, the wheel guide assembly comprises an actuator device with a controllable actuator, particularly a hydraulic or an electromechanical actuator, for displacing the bearing support or the bearing. The controllable actuator can for example dynamically change the position of the bearing support; i.e. during travel, in order to displace the bearing of the wheel control arm. This thereby enables dynamically setting toe and/or a toe gradient as a function of a state of the vehicle.

The actuator can comprise a displaceable piston or a displaceable spindle which acts on the bearing support, respectively the bearing, and thereby effects a displacement of the bearing support or the bearing respectively.

According to one embodiment, the controllable actuator is designed to displace the bearing support or the bearing along a vertical vehicle axis and/or along a transverse vehicle axis or only along a vertical vehicle axis or only along a transverse vehicle axis. Doing so can thus effect a dynamic adjustment of a toe setting or a toe gradient.

According to one embodiment, the controllable actuator is designed to displace, particularly dynamically displace, the bearing support or the bearing in response to receiving a control signal. A communication interface can be provided for receiving the control signal, same being able to receive the control signal from a remote controller. The communication interface can be a CAN communication interface.

According to one embodiment, the actuator device comprises a controller designed to control the controllable actuator as a function of a vehicle state, in particular as a function of a vehicle speed or a vehicle weight or a driver-selected setting such as e.g. Normal, Comfort or Sport in order to displace the bearing support or the bearing. The controller can be realized either on a separate actuator device chip or within a vehicle control system.

According to one embodiment, the controller is designed to determine a target position of the bearing support or the bearing on the basis of the vehicle's state and activate the actuator so as to displace the bearing support or the bearing into the target position. The actuator is designed to displace the bearing support or the bearing into the target position in response to receiving the control signal.

According to one embodiment, the wheel guide assembly comprises a memory for storing a plurality of bearing support or bearing target positions associated with different vehicle states, and whereby the controller is designed to select the target position associated with the vehicle state from said memory.

According to one embodiment, the controller is designed to compare the target position of the bearing support or bearing to an actual position of the bearing support or bearing and activate the actuator upon discrepancy between the actual position and the target position.

According to one embodiment, the actuator device comprises a communication interface, particularly a CAN communication interface, for receiving information on the vehicle state. Driving state information can originate from a vehicle sensor, e.g. a speed sensor, an acceleration sensor or a weight sensor.

According to one embodiment, the bearing support is affixable or affixed directly or by means of an actuator, particularly a hydraulic or electromechanical actuator, to an axle support of a vehicle frame or to a wheel mount.

According to a further aspect, the invention relates to a method for adjusting an alignment of a vehicle wheel by means of a wheel guide assembly, wherein the wheel guide assembly comprises a bearing bolt, a wheel control arm having a bearing which comprises a bearing eye through which a bearing bolt is extended, a bearing support having a first support limb and a second support limb for accommodating the bearing of the wheel control arm, whereby a first guide recess is formed in the first support limb and a second guide recess is formed in the second support limb and wherein the bearing bolt is extended through the first guide recess and the second guide recess, and a first retaining element and a second retaining element, and wherein the method comprises the following steps: the first retaining element and the second retaining element displacing the bearing bolt along the first guide recess and the second guide recess, particularly parallel to a vertical vehicle axis, into a specific mounted position, and the first retaining element being inseparably connected to the first support limb and the second retaining element to the second support limb in order to fix the bearing bolt in the specific mounted position.

Thus, after e.g. the axle components being assembled at the factory, the toe gradient can be checked and adjusted as needed. The final adjustment occurs by a displacing of the wheel control arm bearing into a final mounted position in the bearing support which receives the bearing and which can be mounted on a vehicle frame or on a wheel mount. The wheel control arm bearing is subsequently left in the mounted position and non-displaceably fixed.

The wheel guide assembly according to the invention can be used in realizing the method. Further method steps therefore follow directly from the assembly steps described with respect to the wheel guide assembly.

Reference will be made to the accompanying figures in defining further embodiments. Shown are:

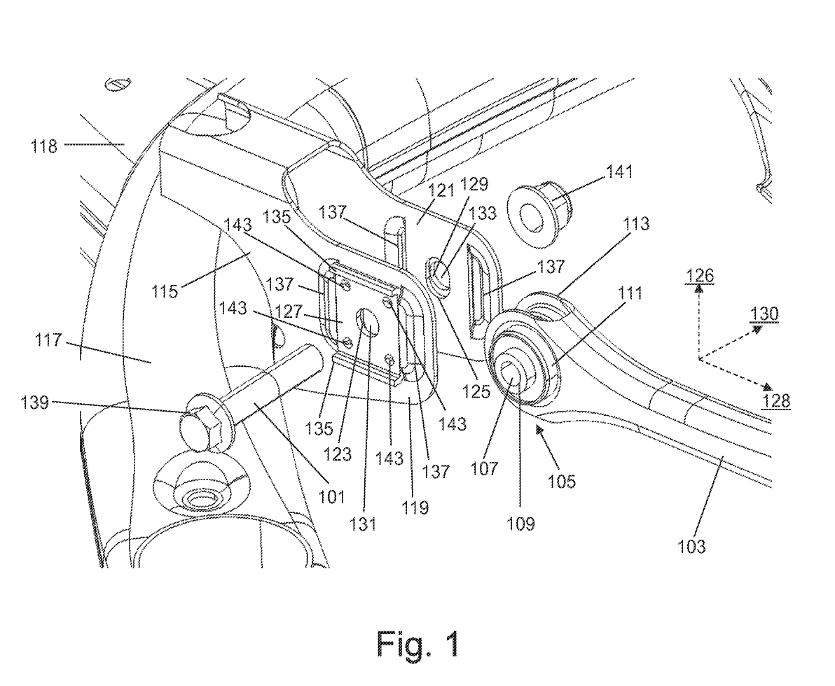

FIG. 1 a schematic exploded view of a wheel guide assembly;

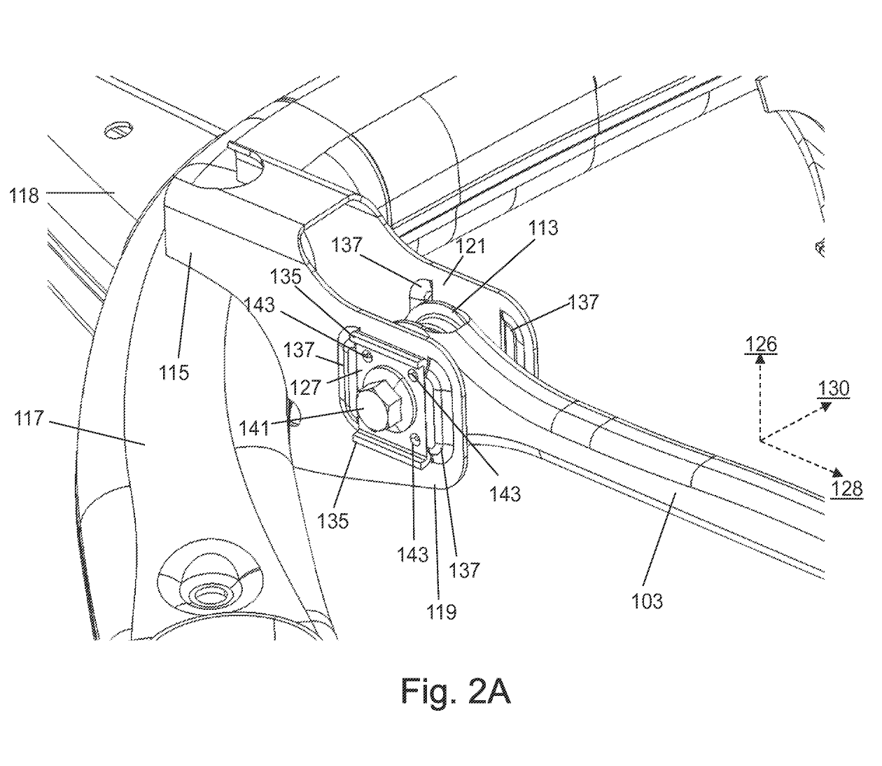

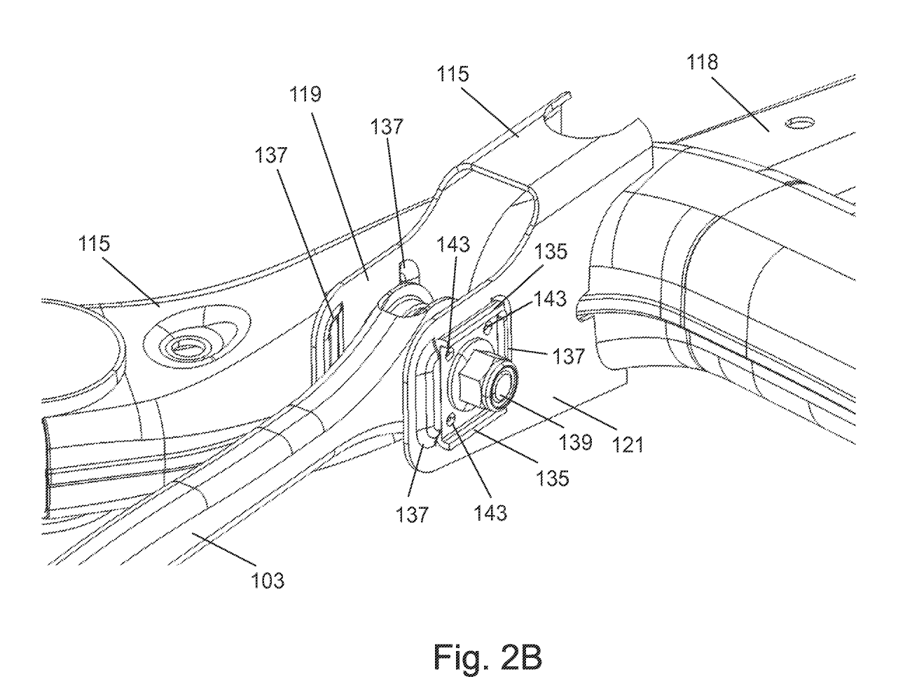

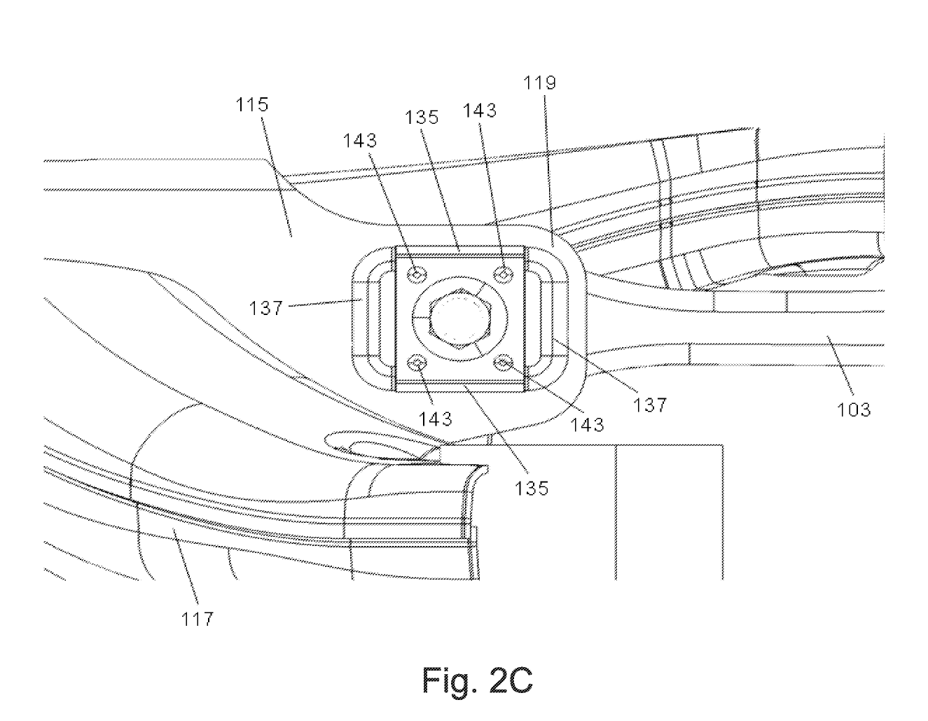

FIG. 2A, B, C schematic representations of the wheel guide assembly depicted in FIG. 1;

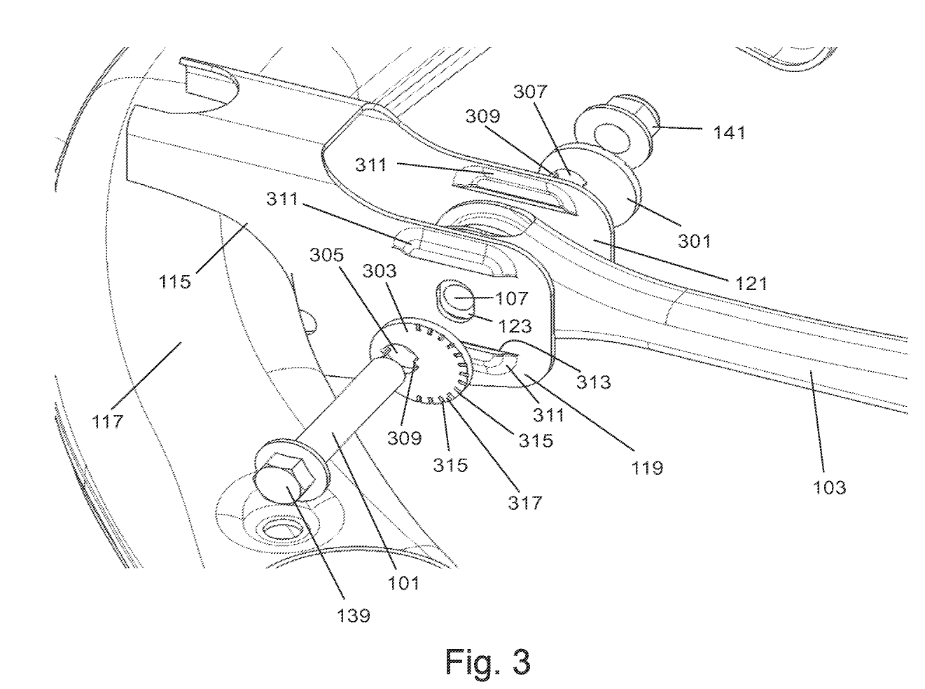

FIG. 3 a schematic exploded view of a wheel guide assembly;

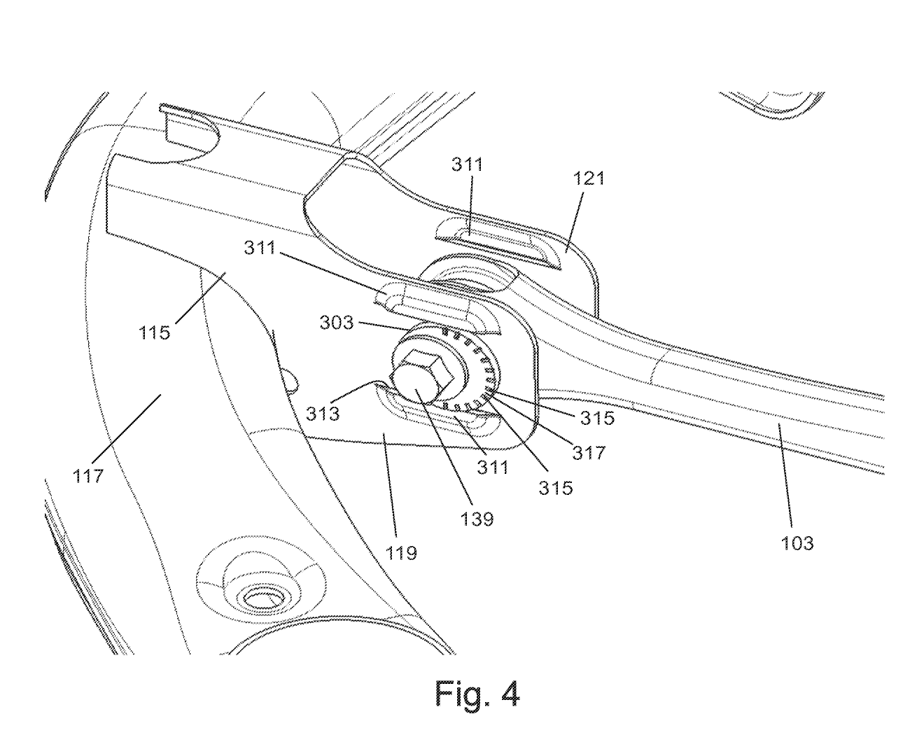

FIG. 4 a schematic representation of the wheel guide assembly depicted in FIG. 3;

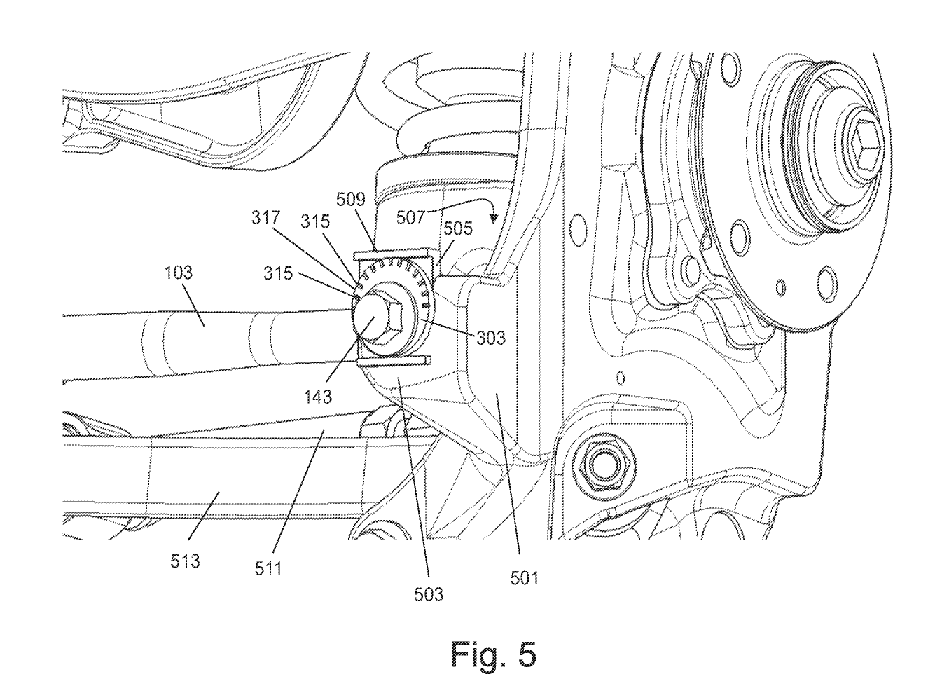

FIG. 5 a schematic representation of a wheel guide assembly;

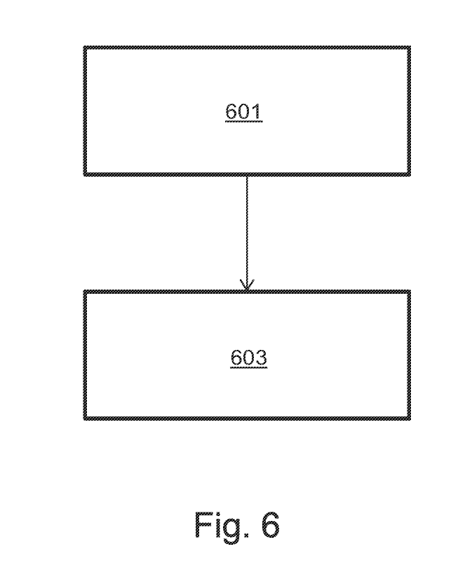

FIG. 6 a schematic flow chart of a method for adjusting a wheel alignment;

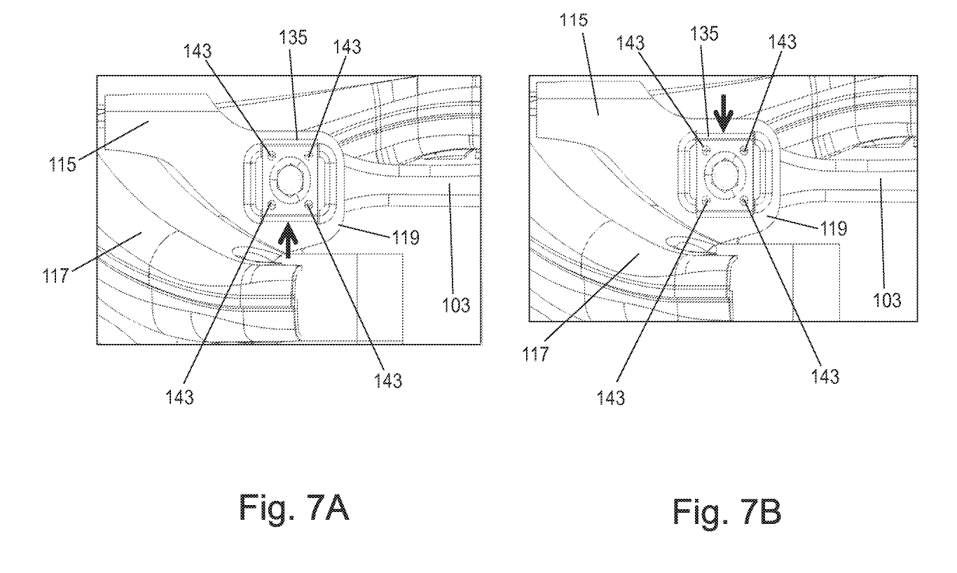

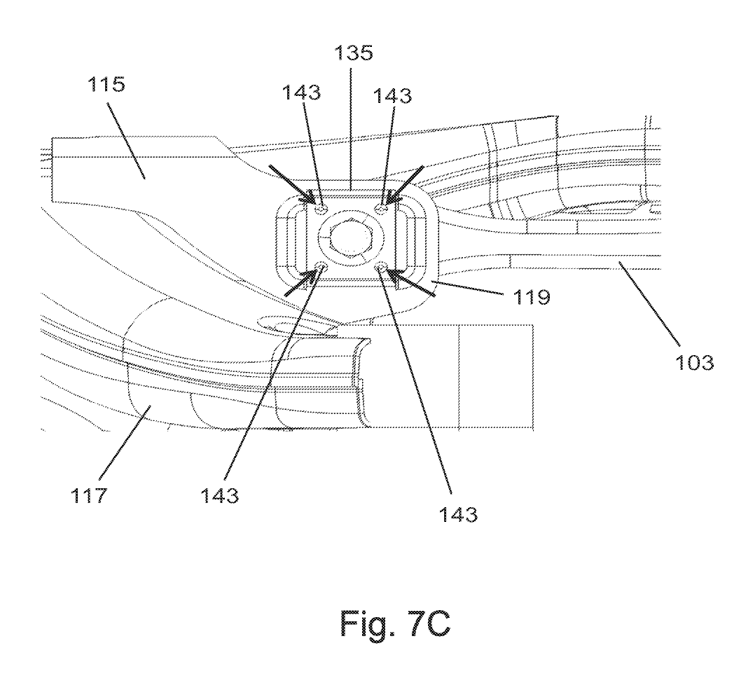

FIG. 7A, B, C method steps by way of example of the assembly depicted in FIG. 1;

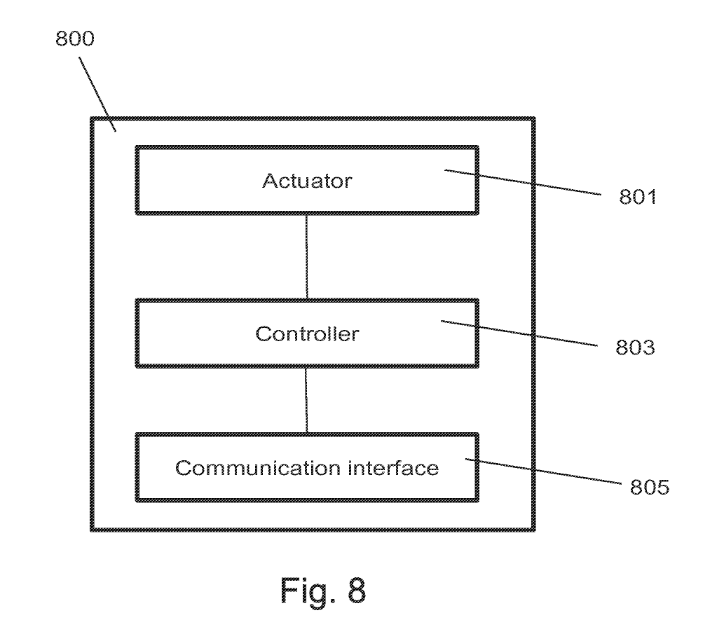

FIG. 8 a schematic diagram of an actuator device; and

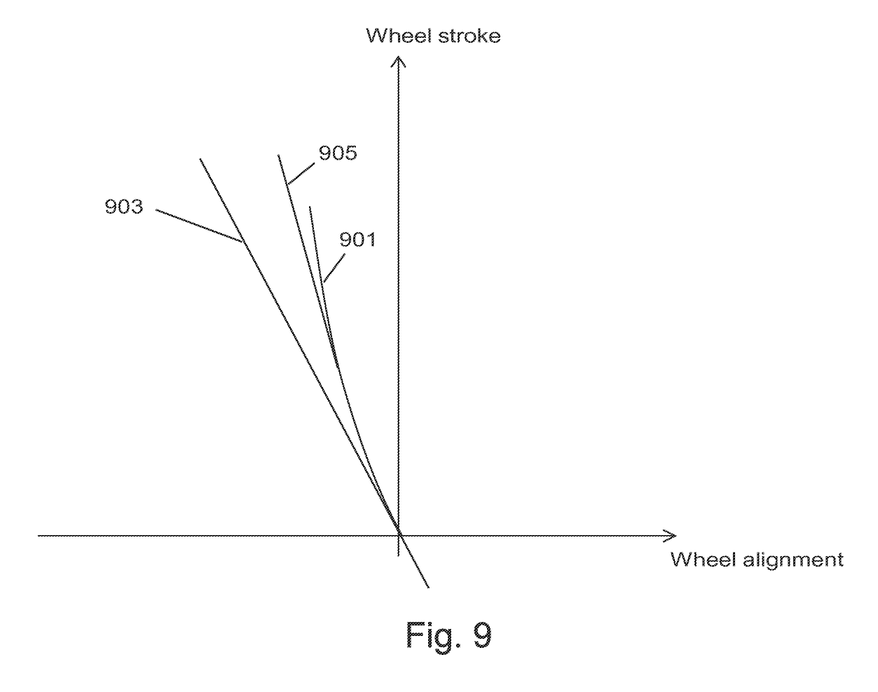

FIG. 9 curve progressions.

FIG. 1 shows a schematic exploded view of a wheel guide assembly according to one embodiment. The wheel guide assembly has a bearing bolt 101 as well as a wheel control arm 103, for example a toe link. The wheel control arm 103 comprises a bearing 105 with a bearing eye 107 formed in a bearing bushing 109. The bearing 103 is for example an elastomer bearing having an elastomer component 111 in which the bearing bushing 109 is embedded. The bearing 103 is rotatably mounted on a bearing end 113 of the wheel control arm 103 by means of the elastomer component 111.

The wheel guide assembly further comprises a bearing support 115 which is for example fixed on an axle support 117 of a vehicle auxiliary frame 118 in the embodiment depicted in FIG. 1. The wheel control arm 103 is articulated or connected respectively by its second end (not depicted in FIG. 2) to for example a wheel mount.

The bearing support 115 has a first support limb 119 and a second support limb 121. The support limbs 119 and 121 are arranged opposite each other and provided to receive the bearing 105 of the wheel control arm 103. The bearing support 115 with support limbs 119, 121 can be integrally formed by a molded part, for example by a curved sheet-metal part. The support limbs 119 and 121 are preferentially identically formed.

A first guide recess 123 is formed in the first support limb 119 and a second guide recess 125 is formed in the second support limb 121 and are in alignment with one another. The guide recesses 123 and 125 are provided for the guided receiving or displacing respectively, particularly parallel displacing, of the bearing bolt 101 which, when installed, extends through the guide recesses 123 and 125.

In the embodiment depicted in FIG. 1, the guide recesses 123 and 125 are designed as straight elongated holes extending along a vertical vehicle axis 126; i.e. in plumb-line direction. The vertical vehicle axis 126 stands perpendicular to a transverse vehicle axis 128 and a longitudinal vehicle axis 130. The guide recesses 123 and 125 can however also be oblique to the vertical vehicle axis 126 at an angle greater than 0° and less than 90°. The guide recesses 123 and 125 can furthermore extend along a curved trajectory. In all cases, a vertical displacement of the bearing bolt 101; i.e. in the vehicle's vertical direction, can be effected. The guide recesses 123 and 125 may be punched out.

The wheel guide assembly further comprises a first retaining element 127 which abuts against the first support limb 119, or an outer wall of the first support limb 119 respectively, and a second retaining element 129 which abuts against the second support limb 121, or an outer wall of the second support limb 121 respectively. The retaining elements 127 and 129 are for example formed as rectangular adjustment plates.

The first retaining element 127 comprises a first support opening 131 and the second retaining element 127 comprises a second support opening 133. The support openings 131 and 133 are dimensioned to correspond to a cross-sectional dimension of the bearing bolt 101, enabling the bearing bolt 101 to be passed through the support openings 131, 133. The support openings 131 and 133 may be punched out.

The retaining elements 127, 129 can respectively comprise one or two parallel arranged grip links 135 which are arranged on opposite ends of the retaining elements 127, 129 and run for example horizontal; i.e. perpendicular to the vertical vehicle axis 126. The grip links 135 enable automatic displacing of the retaining elements 127, 129, e.g. by means of an actuator, in order to displace the pushed-through bearing bolt 101 along the guide recesses 123 and 125 into the specific mounted position. The retaining elements 127, 129 can be configured as adjustment plates.

Two parallel guide projections 137 which extend on both sides and along the respective guide recess 123 and 125 are formed in the support limbs 119 and 121. The guide projections 137 hold the retaining elements 127, 129 laterally and enable a guided displacement of the retaining elements 127, 129 into the specific mounted position.

The guide projections 137 run for example in the direction of the vertical vehicle axis 126.

According to one embodiment, the guide projections 137 are produced by punching or deformation/bulging of the support limbs 119, 121. Openings can hereby be created in the support limbs 119, 121 to form the guide projections 137 via open bulges at the edge.

The guide projections 137 may, however, be molded onto the support limbs 119, 121.

The bearing bolt 101 can be formed as a screw having a screw head 139 and a nut 141. The retaining elements 127, 129 can thus be pre-mounted on the outer sides of the support limbs 119 and 121 via the not yet firmly tightened nut 141 prior to the bearing bolt 101 being displaced into the specific mounted position. By tightening the nut 141, the retaining elements 127, 129 are pressed onto the support limbs 119 and 121. The support limbs 119 and 121 are thereby pressed together, whereby the bearing 107, particularly the bearing bushing 109, is clamped between the support limbs 119 and 121.

The retaining elements 127, 129 furthermore comprise respective clinch points 143 arranged at the corner areas which are provided to produce an inseparable clinch connection between the respective retaining element 127, 129 and the respective support limb 119 and 121. Doing so allows the retaining elements 127, 129 to be set or fixed in the specific mounted position together with the bearing bolt 101.

FIGS. 2A to 2C show schematic views of the wheel guide assembly depicted in FIG. 1 in the assembled state in which the bearing bolt 101 is inseparably fixed in the specific mounted position.

FIG. 3 is a schematic exploded view of a wheel guide assembly according to a further embodiment. Unlike the wheel guide assembly depicted in FIG. 1, the wheel guide assembly depicted in FIG. 3 comprises a first retaining element 301 which abuts the first support limb 119, or an outer wall of the first support limb 119 respectively, and a second retaining element 303 which abuts the second support limb 121, or an outer wall of the second support limb 121 respectively, and which are implemented as eccentric disks.

The retaining elements 301 and 303 comprise respective eccentrically arranged support openings 305 and 307. The function of the support openings 305 and 307 corresponds to that of the support openings 131 and 133 depicted in FIG. 1. Oppositely disposed web elements 309 pointing radially inwardly can further be formed in support openings 305 and 307. The opposing web elements 309 can engage for example in longitudinal slots (not shown in FIG. 3) of the bearing bolt 101. The retaining elements 301 and 303 formed as eccentric disks can thereby be rotated by means of the bearing bolt configured e.g. as a screw. By virtue of the eccentric support openings 305 and 307, the bearing bolt 101 displaces in parallel upon a rotation of the retaining elements 301 and 303 along guide recesses 123 and 125.

In contrast to the embodiment depicted in FIG. 1, the respective support limbs 119 and 121 comprise guide projections 311 on both sides of the guide recesses 123 and 125 which run horizontal, i.e. perpendicular to the vertical vehicle axis 126, and which support the retaining elements 301 and 303 configured as eccentric disks. The guide projections 311 can comprise further supports 313 to support the retaining elements 301 and 303, on which the retaining elements 301 and 303 formed as eccentric disks can slide in supported manner when rotating. The bearing bolt 101 can thus be vertically raised and/or lowered upon a rotation of the retaining elements 301 and 303.

The guide projections 311 can be formed in the same way as guide projections 137.

The retaining elements 301 and 303 formed as eccentric disks further comprise radially directed notches 315, whereby a radially directed grip link 317 is formed between two adjacent notches 315. The grip links 317 enable a continuous rotation of the retaining elements 301 and 303, e.g. by means of an actuator, in order to displace their pushed-through bearing bolt 101 along the guide recesses 123 and 125 into the specific mounted position. The functioning of the wheel guide assembly depicted in FIG. 3 corresponds to the functioning of the wheel guide assembly depicted in FIG. 1.

FIG. 4 is a schematic view of the wheel guide assembly depicted in FIG. 3 in the assembled state.

In FIGS. 1 to 4, the bearing supports 101 are mounted on the vehicle body side, for example on the axle support 117 of an auxiliary frame of the vehicle. According to one embodiment, the wheel guide assemblies depicted in FIGS. 1 to 4 can be for example mounted on a wheel mount.

To articulate the bearing 105 of the wheel control arm 103, a bearing support comprising support limbs having guide recesses formed therein for the guided displacement of the bearing bolt into a specific mounted position can be formed in the wheel mount analogously to the embodiments depicted in FIGS. 1 to 4, as is shown in FIG. 5.

FIG. 5 is a schematic view of a wheel guide assembly arranged on the wheel side of a wheel mount. In contrast to the embodiments depicted in FIGS. 1 to 4, the bearing 105 of the wheel control arm 103 is articulated directly to the wheel mount 501. To this end, a bearing support 503 having a first support limb 505 and an identical second support limb 507 is formed in the wheel mount 501 analogously to the embodiments depicted in FIGS. 1 to 4. The support limbs 505 and 507 can be integral elements of the wheel mount 501.

According to one embodiment, the support limbs 505 and 507 can be formed as in the embodiment depicted in connection with FIG. 1. The retaining elements 127, 129 depicted in FIG. 1 can thus be used to displace the bearing bolt.

In the embodiment depicted in FIG. 5, the wheel guide assembly comprises for example the retaining elements 301 and 303 formed as eccentric disks. Parallel guide bars 509 are formed in the wheel mount 501 to horizontally support the retaining elements 301 and 303. The functioning of the wheel guide assembly depicted in FIG. 5 thus corresponds to the functioning of the wheel guide assembly depicted in FIG. 3.

Additionally to wheel control arm 103, further wheel control arms 511, 513 can be provided, e.g. transverse links or auxiliary links, their linkages displaceably mountable.

FIG. 6 shows a schematic sequence of a method for adjusting a vehicle wheel alignment by means of one of the wheel guide assemblies shown in FIGS. 1 to 5. The method comprises the first retaining element 127, 301 and the second retaining element 129, 303 displacing 601 the bearing bolt 101 along the first guide recess 123 and the second guide recess 125, in particular parallel to the vertical vehicle axis 126, into a specific mounted position, as well as the inseparable connecting 603 of the first retaining element 131, 301 to the first support limb 119, 505 and the second retaining element 129, 303 to the second support limb 121, 507 in order to fix the bearing bolt 101 in the specific mounted position.

FIGS. 7A to 7C show steps 601 and 603 of setting and/or adjusting the wheel alignment of a wheel using the example of the wheel guide assembly depicted in FIG. 1.

FIGS. 7A and 7B show a pre-assembled state of the wheel guide assembly in which the pre-assembled mounting elements of the wheel guide assembly are installed and the screw connection of the bearing bolt 101 configured for example as a screw is not tightened.

After the pre-assembly, the toe gradient can be measured and the optimized specific mounted position or positions can be determined in an intermediate step.

As is further shown in FIGS. 7A and 7B, the retaining elements 127, 129 for setting the specific mounted position of the bearing bolt 101, or bearing 105 together with bearing bolt 101 respectively, can be vertically displaced, e.g. raised or lowered, in the direction of the arrows depicted in FIGS. 7A and 7B, for example in the final assembly, thereby allowing the setting or adjusting of the toe gradient.

Thereafter, in step 603, the retaining elements 127, 129 configured as adjustment plates are securely fixed to the bearing support 115 in order to set the final toe gradient. An inseparable fixing can be realized for example by welding, clinching, bonding or pressing. Doing so thus permanently ensures an optimal toe gradient and prevents the occurrence of inaccurate resetting during service or improper adjustments.

The inseparable connection enables the static setting of the toe or the toe gradient. For dynamic setting or adjusting of the toe setting or the toe gradient, an actuator can be additionally provided which is for example arranged between the bearing block and the vehicle frame or wheel mount.

FIG. 8 shows a schematic diagram of an actuator device 800 having a controllable actuator 801 and a controller 803 for controlling the actuator.

The actuator 801 can for example be a hydraulic actuator or an electromechanical actuator, e.g. an electric motor. The actuator 801 can be arranged between the bearing support 115 and the axle support 117 and provided to change a position of the bearing 105 by way of displacing the bearing support 115, for example in the direction of vertical vehicle axis 126. So doing allows a toe setting and/or a toe gradient to be dynamically adapted to a state of the vehicle. The vehicle state can include the vehicle speed and/or vehicle payload and/or vehicle weight. By the position of the wheel control arm 103 linkage dynamically adapting in response to the displacement of the bearing support 115, the influence of dynamic changes in the vehicle's state on a toe gradient or on a toe setting can be factored in or reduced.

The controllable actuator 801 is preferentially designed to displace the bearing support 115 along the vertical vehicle axis 126 and/or along a transverse vehicle axis 128 or solely along the vertical vehicle axis 126 or solely along the transverse vehicle axis 128. Doing so allows both the toe setting as well as the toe gradient to be dynamically adapted to the vehicle condition.

According to one embodiment, the actuator device 800 comprises a communication interface 805, particularly a CAN communication interface, which can be enabled for example at a vehicle communication bus in order for information on the state of the vehicle to be received via the vehicle communication bus. The information on the state of the vehicle can originate for example from vehicle sensors.

According to one embodiment, the controller 803 is designed to determine a target position of the bearing support 115 based on the vehicle state and activate the actuator 801 so as to displace the bearing support 115 into said target position.

The controller 803 can however also be designed to determine a target position of the bearing 105 based on the vehicle state and activate the actuator 801 to displace the bearing support 115 so as displace the bearing 105 into the target position.

Displacing the bearing support 115 into the target position enables the toe setting or the toe gradient to be adjusted as is depicted in FIG. 9. FIG. 9 shows curve progressions of a wheel alignment as a function of wheel stroke. Wheel stroke is generally dependent on vehicle state. By changing the wheel stroke, the statically set wheel alignment follows the actual progression 901, its actual gradient 903 and thus also the actual toe gradient differing from a target gradient 905 and thus also from the target toe gradient. The dynamic displacing of the bearing support 115 position changes the linkage of the wheel control arm 103, whereby the toe setting and/or the toe gradient can be dynamically adapted to the respective state of the vehicle.

### LIST OF REFERENCE NUMERALS

101 bearing bolt
103 wheel control arm
105 bearing
107 bearing eye
109 bearing bushing
111 elastomer component
113 bearing end
115 bearing support
117 axle support
118 frame
119 first support limb
121 second support limb
123 first guide recess
125 second guide recess
126 vertical vehicle axis
127 first retaining element
128 transverse vehicle axis
129 second retaining element
130 longitudinal vehicle axis
131 first support opening
133 second support opening
135 grip link
137 guide projection
139 screw head
141 screw nut
143 clinch point
301 first retaining element
303 second retaining element
305 first support opening
307 second support opening
309 web element
311 guide projection
313 support
315 notch
317 grip link
501 wheel mount
503 bearing support
505 first support limb
507 second support limb
509 guide bar
511 wheel control arm
513 wheel control arm
601 displacement
603 connection
800 actuator device
801 actuator
803 controller
805 communication interface
901 actual curve progression
903 actual gradient
905 target gradient

1. A wheel guide assembly for a wheel of a vehicle, comprising:
a bearing bolt;
a wheel control arm which comprises a bearing with a bearing eye, wherein the bearing bolt is extended through the bearing eye;
a bearing support having a first support limb and a second support limb for accommodating the bearing of the wheel control arm, wherein a first guide recess is formed in the first support limb and a second guide recess is formed in the second support limb for the guided displacement of the bearing bolt into a specific mounted position, wherein the bearing bolt is extended through the first guide recess and the second guide recess; and
a first retaining element and a second retaining element which hold the bearing bolt in the specific mounted position in the first guide recess and in the second guide recess, wherein the first retaining element is inseparably connectable to the first support limb and wherein the second retaining element is inseparably connectable to the second support limb.

2. The wheel guide assembly according to claim 1, wherein the wheel control arm is a toe link.

3. The wheel guide assembly according to claim 1, wherein a longitudinal axis of the first guide recess and a longitudinal axis of the second guide recess extend perpendicular to a vertical vehicle axis.

4. The wheel guide assembly according to claim 1, wherein the first guide recess and the second guide recess are each formed by an elongated hole, particularly a vertical elongated hole.

5. The wheel guide assembly according to claim 1, wherein the first retaining element comprises a first support opening which is disposed above the first guide recess in the specific mounted position, wherein the second retaining element comprises a second support opening which is disposed above the second guide recess in the specific mounted position, and wherein the bearing bolt is extended through the first support opening and the second support opening.

6. The wheel guide assembly according to claim 1, wherein the first retaining element and the second retaining element are each formed as at least one of an adjustment plate and an eccentric disk.

7. The wheel guide assembly according to claim 1, wherein the first retaining element is inseparably connectable to the first support limb and the second retaining element is inseparably connectable to second support limb by at least one of the following inseparable connections: welded joint, rivet joint, solder joint, bonded joint, clinch connection and a pressing action.

8. The wheel guide assembly according to claim 1, comprising an actuator device having a controllable actuator, for displacing at least one of the bearing support and the bearing.

9. The wheel guide assembly according to claim 8, wherein the controllable actuator is designed to displace at least one of the bearing support and the bearing along at least one of a vertical vehicle axis and a transverse vehicle axis.

10. The wheel guide assembly according to claim 8, wherein the actuator device comprises a controller designed to control the controllable actuator as a function of a vehicle state in order to displace at least one of the bearing support and the bearing.

11. The wheel guide assembly according to claim 10, wherein the controller is designed to determine a target position of at least one of the bearing support and the bearing on the basis of the state of the vehicle and activate the actuator to displace at least one of the bearing support and the bearing into the target position.

12. The wheel guide assembly according to claim 11 comprising a memory for storing a plurality of target positions for at least one of the bearing support and the bearing associated with different vehicle states, and wherein the controller is designed to select the target position associated with the vehicle state from said memory.

13. The wheel guide assembly according to claim 10, wherein the actuator device comprises a communication interface, for receiving information on the vehicle state.

14. The wheel guide assembly according to claim 1, wherein the bearing support is at least one of directly affixed and by means of an actuator to an axle support of at least one of a vehicle frame and to a wheel mount.

15. A method for adjusting an alignment of a vehicle wheel by means of a wheel guide assembly, wherein the wheel guide assembly comprises a bearing bolt, a wheel control arm having a bearing that comprising a bearing eye through which a bearing bolt is extended, a bearing support having a first support limb and a second support limb for accommodating the bearing of the wheel control arm, wherein a first guide recess is formed in the first support limb and a second guide recess is formed in the second support limb and wherein the bearing bolt is extended through the first guide recess and the second guide recess, and a first retaining element and a second retaining element, and wherein the method comprises the following steps:
displacing, by the first retaining element and the second retaining element, the bearing bolt along the first guide recess and the second guide recess into a predetermined mounted position; and
fixing the bearing bolt in the predetermined mounting position by the first retaining element being inseparably connected to the first support limb and the second retaining element being inseparably connected to the second support.

16. The wheel guide assembly according to claim 8, wherein the controllable actuator is at least one of a hydraulic actuator and an electromechanical actuator.

17. The wheel guide assembly according to claim 10, wherein the function of a vehicle state comprises a function of at least one of a vehicle speed, a vehicle weight, and a vehicle payload.

18. The wheel guide assembly according to claim 13, wherein the communication interface is a CAN communication interface.

19. The wheel guide assembly according to claim 14, wherein the bearing support is affixed by at least one of hydraulic and electromechanical actuator.

20. The method for adjusting an alignment of a vehicle wheel according to claim 15, wherein the step of displacing is parallel to a vertical vehicle axis.
